(19) United States
(12) Patent Application Publication
(10) Pub. No.: US 2008/0136255 A1
(43) Pub. Date: Jun. 12, 2008

(54) ENDLESS TRACK BELT AND METHOD OF MAKING SAME

(75) Inventors: Thomas Brian Feldmann, Hamilton, OH (US); Paul John Peterson, Cuyahoga Falls, OH (US)

Correspondence Address: WOOD, HERRON & EVANS, LLP, 2700 CAREW TOWER, 441 VINE STREET, CINCINNATI, OH, 45202, US

(73) Assignee: VEYANCE TECHNOLOGIES, INC., Fairlawn, OH (US)

(21) Appl. No.: 11/954,792

(22) Filed: Dec. 12, 2007

Related U.S. Application Data
(60) Provisional application No. 60/874,390, filed on Dec. 12, 2006.

(51) Int. Cl. B62D 55/24; B29C 70/00

(52) U.S. Cl. 305/167; 264/241

(57) ABSTRACT

An endless track belt for use in an industrial or agricultural vehicle is described. The endless rubber track belt includes a rubber carcass having an inner surface having one or more drive lugs and an outer surface having tread lugs. The drive lugs include reinforcement layers that partially or substantially cover all or a portion of the end faces of the drive lugs. The reinforcement layers may include continuous strips, or discrete strips. The reinforcement layer may also be fabric cutouts to match the shape of the drive end faces of the drive lugs.

### CROSS REFERENCE TO RELATED APPLICATIONS

This application claims the benefit of U.S. Provisional Application No. 60/874,390, filed Dec. 12, 2006 (pending), the disclosure of which is incorporated by reference herein in its entirety.

### TECHNICAL FIELD

This invention relates to endless rubber track belts.

### BACKGROUND

Positive drive, endless rubber tracks such as those used on agricultural or industrial vehicles typically have an internal, center ribbon of individual drive lugs which engage drive bars on a drive wheel. The continued use and contact between the drive bar and drive lugs cause internal lug stresses, and surface wear at the points of contact. Additionally, the internal, center ribbon of lugs are typically functioning not only to transmit power from the drive wheel to the track, but also to retain the track on the vehicle. Contact between the vehicle undercarriage wheels and longitudinal guide surfaces of the inner lugs frequently occurs as the vehicle maneuvers during normal service. This contact can cause wearing of the inner lugs, which can be severe, depending upon various vehicle design features and application use. Driving and/or guiding forces on the inner lugs, henceforth referred to as guide-drive lugs, can lead to cracks and eventual chunking of the rubber surface, and possibly to complete removal of the drive lugs, making the track unserviceable. Thus, a track belt having guide-drive lugs which are stronger and more resistant to wear is desired.

### SUMMARY

The invention provides in a first aspect an endless rubber track belt comprising a rubber carcass having an inner surface with one or more guide-drive lugs, and an outer surface having tread lugs. The guide-drive lugs include reinforcement layers that completely or partially cover the drive end faces of the drive lugs.

### BRIEF DESCRIPTION OF THE FIGURES

FIG. 1 is an elevation view of an exemplary endless rubber track assembly.

FIG. 2 is a perspective view of a section of the exemplary endless rubber track shown in FIG. 1.

FIG. 3 is a cross-sectional view of the endless rubber track of FIG. 2, taken generally along line 3-3 in FIG. 2.

FIG. 4 is a cross-sectional view of the endless rubber track of FIG. 2, taken generally along line 4-4 in FIG. 2.

FIG. 5 is a perspective view of a section of a second embodiment of an endless rubber track.

FIGS. 6-9 illustrate additional embodiments of reinforcement applied to the end faces of the drive lugs.

### DETAILED DESCRIPTION

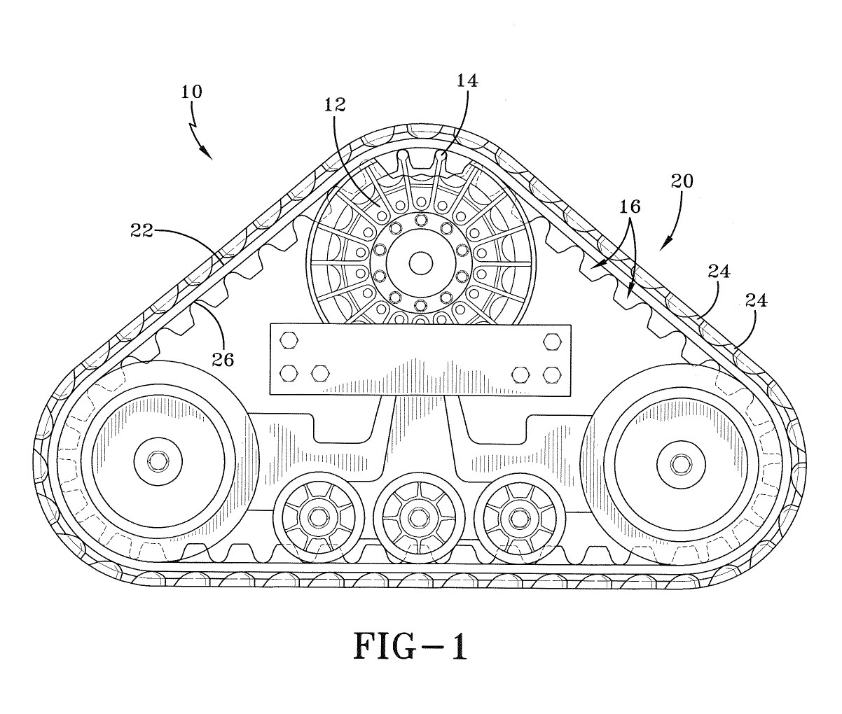

FIG. 1 illustrates a track assembly 10 which may be used on an industrial or agricultural vehicle (not shown). The track assembly 10 includes a drive wheel 12 comprising a plurality of teeth or drive bars 14 that are positioned for mating engagement with guide-drive lugs 16. The drive lugs 16 are mounted on a rubber track 20 having an endless elongate carcass. The endless track carcass has an outer surface 22 comprising a plurality of ground engaging tread lugs 24 and an inner surface 26 with a plurality of guide-drive lugs 16, typically located on the center portion of the carcass.

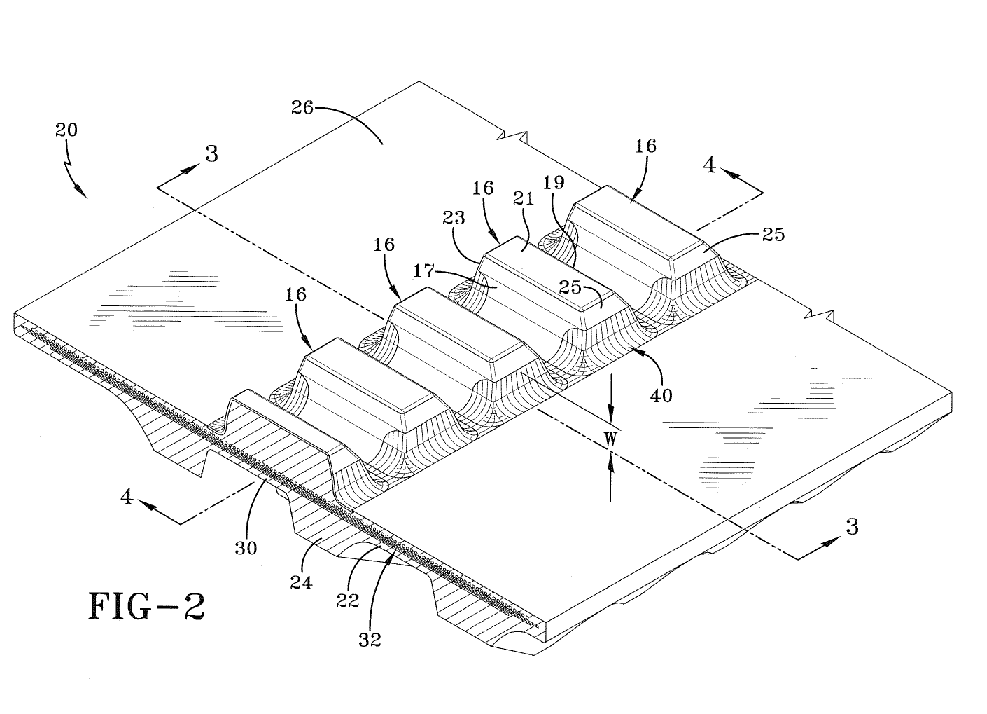

As shown in FIG. 2, each guide-drive lug 16 comprises an elongate shaped bar with inclined drive faces 17, 19, and an upper flat face 21. The corners of the joined faces are rounded to reduce stress concentrations. End faces 23, 25 may be flat. The guide-drive lugs 16 may also have various other shapes.

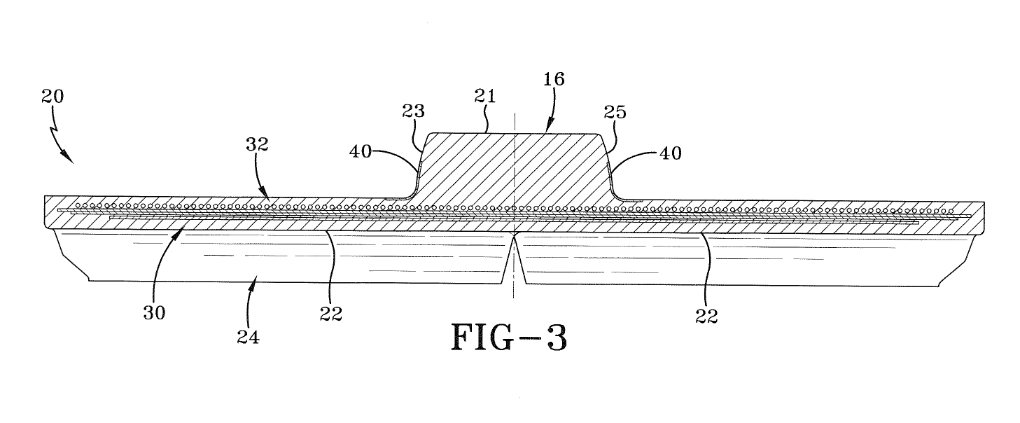

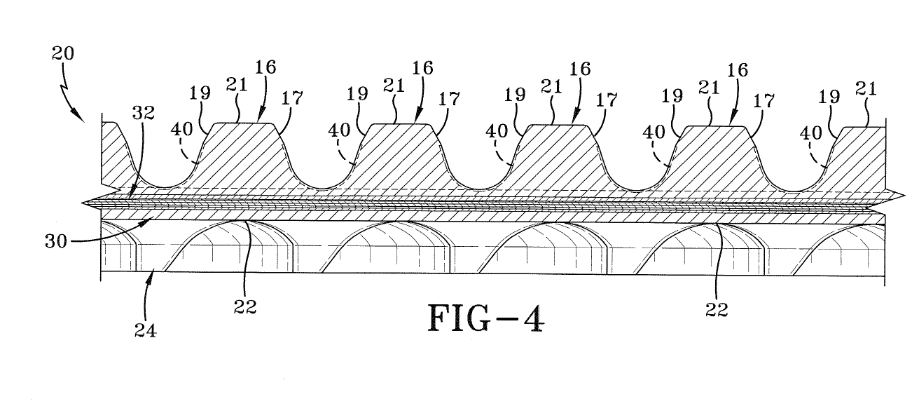

As shown in FIGS. 3 and 4, the belt carcass 20 typically comprises one or more layers of gum rubber or elastomeric material 30. Embedded within the gum rubber are one or more reinforcement layers 32 which extend transversely along the track width. The reinforcement layers 32 may comprise longitudinal cable reinforcement layers, fabric reinforcement layers, or any other reinforcement layer known to those skilled in the art.

The guide-drive lugs 16, as shown in FIGS. 2-4, comprise rubber or elastomeric material. As shown in FIG. 2, the belt carcass 20 has one or more continuous strips 40 of reinforcement material having a width W. Each lug may have one or more layers of strips applied to the end faces 23, 25. The strips 40 may be located on the inner surface 26 or embedded therein at a desired depth. The reinforcement strip 40 may partially or completely cover the drive lug end faces 23, 25 and may partially extend down the drive faces 17, 19 of the lugs 16 onto the carcass. It may be desired that about 30% of the lug end face area be covered, although the amount of coverage may range from about 20% to about 100%. The width W of the strip 40 may vary from about 5% to about 50% of the track width. The reinforcement strip 40 may also optionally extend continuously all the way around the track 20, having a sufficient width to partially or fully cover the drive lug faces 17, 19, 23, 25 and extend to partially cover the adjacent carcass inner surface 26 in the area of the wheel paths. The reinforcement strip 40 provides a protective effect to the drive lugs 16 and the inner carcass transition area.

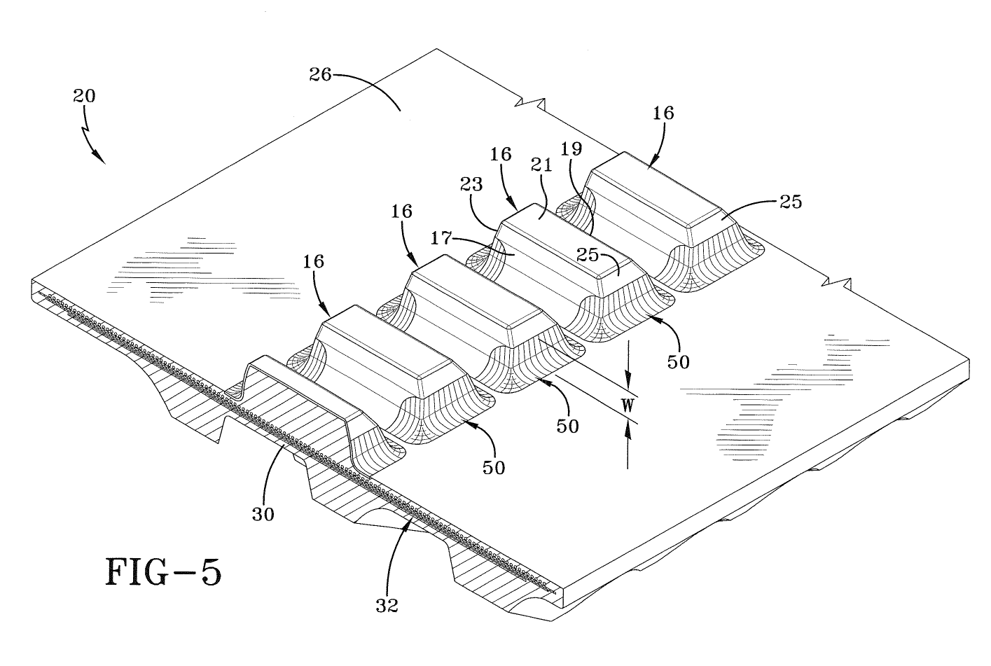

FIG. 5 illustrates a second exemplary embodiment of a track 20 in accordance with the present disclosure. FIG. 5 is similar to FIG. 2, except that the reinforcement layer 40 has been replaced with individual reinforcement pieces 50. The reinforcement pieces 50 have a width W, wherein side portions of the pieces 50 extend to partially cover the drive lug end faces 23, 25 and extend to partially cover the adjacent carcass. It may be desired that about 30% of the lug end face area be covered, although the amount of coverage may range from about 20% to about 100%. Although not shown, the width W of the pieces 50 may vary from about 5% to about 50% of the track width. Alternatively, the pieces 50 may extend to substantially cover the drive lug end faces 23, 25 and the carcass area adjacent to the drive lugs 16 in the wheel path.

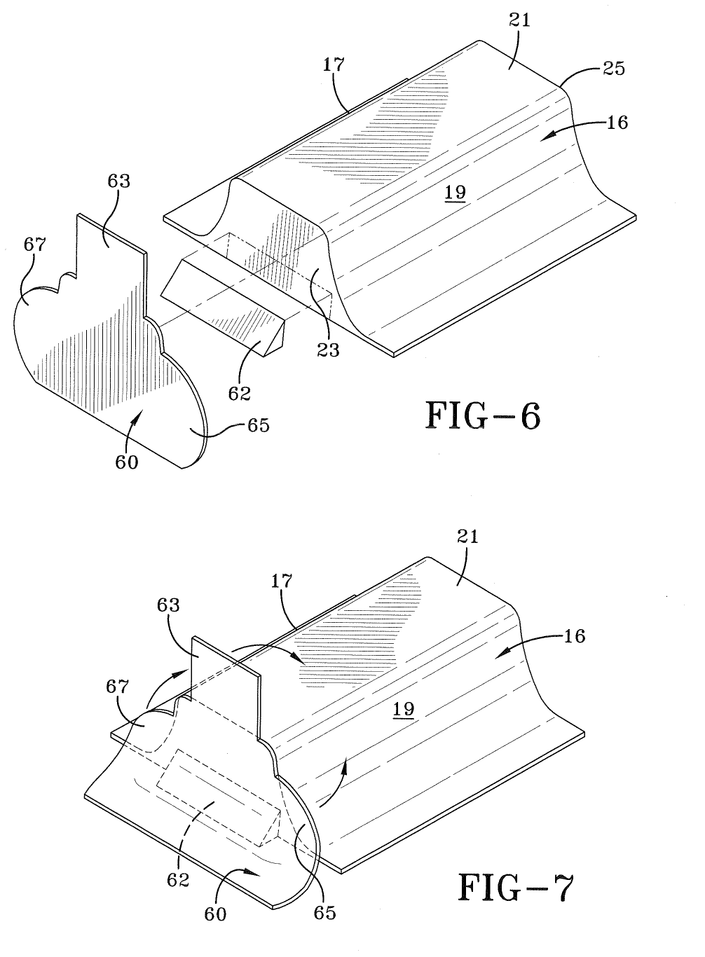

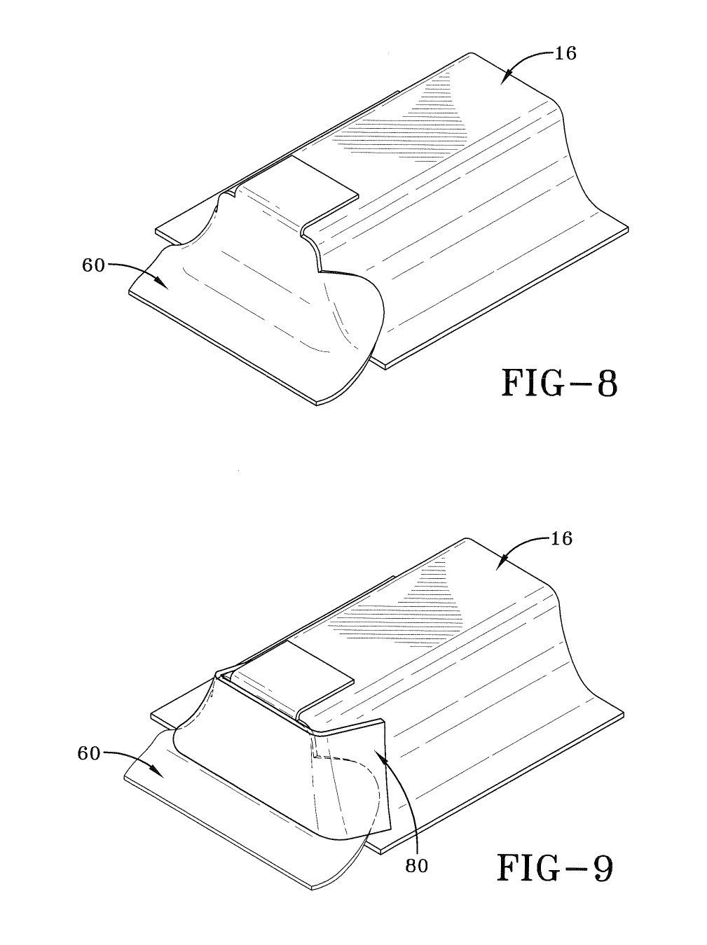

FIG. 6 illustrates a third exemplary embodiment of a drive lug 16 in accordance with the present disclosure. In this embodiment, reinforced fabric cutouts 60 in the shape of the lug end face 23, 25 are applied to the drive lug end faces 23, 25 prior to vulcanization. The cutouts 60 may have one or more optional tabs 63, 65, and 67 that may be folded over the edges of the guide faces 23, 25. As shown in FIG. 8, one of the optional tabs 63 may be folded over and located on the upper face 21 of the drive lug 16. Additional optional tabs 65 may be folded over and located on the drive faces 17, 19.

As shown in FIGS. 6 and 7, an optional wedge of rubber 62 may be placed next to the lug faces 23, 25 at the intersection with the carcass. The reinforcement fabric 60 is then placed over the rubber wedge 62. Alternatively, the wedge 62 may be placed above the reinforcement fabric 60. As shown in FIG. 9, an optional piece of thin rubber 80 may be placed over reinforcement fabric 60 or in any of the above-described embodiments. The rubber piece 80 may be sized to completely cover the end faces 23, 25 and extend over the edge onto drive faces 17, 19.

The reinforcements 40, 50 or cutouts 60, may comprise the following materials: nylon, polyester, polyethylene, polyurethane, rayon, Kevlar, aramid, metal, natural fibers such as cotton, glass fibers, carbon fibers, ceramic fibers, or plastic fibers. The reinforcement material may also be a fiber loaded rubber layer, with fibers oriented in a transverse direction or in a random direction. For example, the reinforcement may be tire ply made of nylon cord. The tire cord may be bias cut at +/−45 degrees, and applied in two layers of opposite senses. The fibers may be natural fibers such as cotton, nylon, polyester, polyethylene, polyurethane, rayon, glass fibers, steel, or plastic. The invention is not limited to the reinforcement materials stated above, and may also comprise any low friction material considered suitably effective for the specific type of track belt usage. It is preferable that the reinforcement material having a low coefficient of friction in the range of about 0.10 to about 0.80.

The reinforcement material may comprise the track inner surface or be embedded under the track inner surface at a distance, the distance typically being in the range of about 0.020 inch to about 0.130 inch, but not limited thereto. Preferably, the reinforcement layer is covered on both sides with a skim coat layer of rubber.

The reinforcement layer is preferably incorporated into the track belt during the track belt manufacturing process. In this case, the reinforcement material is prepared independently, and prior to, the track manufacturing process. The track belt can be formed and vulcanized in a pressurized molding process. Molds used in the process have shaped lug cavities which form guide-drive lugs into their intended final shape. The guide-drive lugs can be presented to the final molding process as extruded pieces, which are cut to length, approximately the shape of the lug cross sectional contour. At the end they may be cut on a bias to more approximate the ends of the mold cavities. Otherwise, the lugs may be pre-molded similar to what is illustrated in U.S. Pat. No. 5,536,464.

The slugs can be covered individually with separate pieces of reinforcing material prior to lugs being presented to the track belt build and vulcanization process. Alternatively, the guide-drive lug reinforcing material can be applied to the particular surfaces as a continuous piece. In this method, the prepared inner lug slugs are positioned onto the inside surface of the uncured carcass at their intended final molded relative locations. Then, prior to molding, the single piece of reinforcement is placed over the green inner lug slugs. Additional fitting of the reinforcement to the green inner slugs may be done at this time; however, the process of compressing the mold may also be relied on to form fit the reinforcement over the intended surfaces.

After the reinforcement has been fitted to inner lug slugs, final vulcanization occurs via imparting appropriate pressure and temperature onto the uncured track belt. This is the final step in incorporating the guide-drive reinforcement to the track belt.

While certain representative embodiments and details have been shown for the purpose of illustrating the invention, it will be apparent to those skilled in this art that various changes and modifications may be made therein without departing from the spirit or scope of the invention. The various features shown and described herein may be used alone or in any combination.

What is claimed is:

1. An endless rubber track belt, comprising:
an endless, elongate carcass including an outer surface and an inner surface;
a plurality of tread lugs disposed on said outer surface;
a plurality of drive lugs disposed on said inner surface, each said drive lug including oppositely disposed drive faces, an upper face between said drive faces, and oppositely disposed end faces; and
at least one layer of reinforcement material covering at least a portion of at least one of said end faces of at least one of said drive lugs.

2. The endless rubber track belt of claim 1, wherein said reinforcement material completely covers said drive lug.

3. The endless rubber track belt of claim 1, further comprising:
an intermediate member adjacent said end face and said inner surface of said carcass.

4. The endless rubber track belt of claim 1, wherein said reinforcement material comprises plural layers of material.

5. The endless rubber track belt of claim 1, wherein said reinforcement material extends over said end face onto at least one of said drive faces or said upper face.

6. The endless rubber track belt of claim 1, wherein said reinforcement material is shaped to correspond to the shape of said end face.

7. The endless rubber track belt of claim 1, wherein said reinforcement material extends onto said inner surface of said carcass.

8. The endless rubber track belt of claim 1, wherein said reinforcement material comprises a plurality of discrete strips of material arranged adjacent one another to cover at least a portion of said end face.

9. The endless rubber track belt of claim 1, further comprising:
a secondary rubber layer disposed over said reinforcement material and extending between said end face and said inner surface of said carcass.

10. The endless rubber track belt of claim 9, wherein said secondary rubber layer extends onto at least one of said drive faces.

11. The endless rubber track belt of claim 1, wherein said reinforcement material is at least partially embedded into said end face.

12. A method of making an endless rubber track belt, the method comprising:
placing an uncured endless track carcass into a mold;
positioning at least one drive lug on an inner surface of the carcass, the drive lug including oppositely disposed drive faces and oppositely disposed end faces;
positioning at least one layer of reinforcing material to cover an end face of the drive lug; and
curing the carcass.

13. The method of claim 12, wherein positioning the reinforcing material comprises:
arranging a single piece of reinforcing material to cover the end faces of plural drive lugs.

14. The method of claim 12, wherein positioning the reinforcing material comprises:
arranging individual pieces of reinforcing material to cover respective end faces of individual drive lugs.

15. The method of claim 12, further comprising:
positioning an intermediate member adjacent the end face and the inner surface of the carcass.

16. The method of claim 12, further comprising:
positioning a secondary rubber layer over the reinforcement material and extending between the end face and the inner surface of the carcass.
